(19) United States
(12) Patent Application Publication
(10) Pub. No.: US 2005/0012817 A1
(43) Pub. Date: Jan. 20, 2005

(54) Selective surveillance system with active sensor management policies

(75) Inventors: Arun Hampapur, Fairfield, CT (US); Sharathchandra Pankanti, Mt. Kisco, NY (US); Andrew W. Senior, New York, NY (US); Ying-Li Tian, Yorktown Heights, NY (US); Lisa M. Brown, Pleasantville, NY (US); Rudolf M. Bolle, Bedford Hills, NY (US)

Correspondence Address: DILWORTH & BARRESE, LLP, 333 EARLE OVINGTON BLVD., UNIONDALE, NY, 11553, US

(73) Assignee: INTERNATIONAL BUSINESS MACHINES CORPORATION, Armonk, NY (US)

(21) Appl. No.: 10/620,247

(22) Filed: Jul. 15, 2003

(51) Int. Cl. H04N 7/18

(52) U.S. Cl. 348/143; 348/169

(57) ABSTRACT

A system and method for selectively monitoring movement of one or more objects having one or more object attributes in a three dimensional space. The method is achieved by following the steps of detecting a position of the one or more objects in the three dimensional space by collecting information from one or more static sensors; selecting each detected object for monitoring; uniquely identifying selected objects and assigning one or more variable sensors to monitor the uniquely identified object. The method further requires gathering information from the variable sensors for each identified object; detecting a direction of each identified object in the three dimensional space; and controlling the one or more variable sensors to continuously point to the assigned uniquely identified object.

### BACKGROUND OF THE INVENTION

1. Field of the Invention

This invention relates to a surveillance system and method and, more specifically, to surveillance of one or more selected objects in a three dimensional space, where information is gathered about the selected objects.

2. Description of the Related Art

Visual tracking of moving objects is a very active area of research. However, there are relatively few efforts underway today that address the issue of multi-scale imaging. Some of these efforts include Peixoto, Batista and Araujo, “A Surveillance System Combining Peripheral and Foveated Motion Tracking,” ICPR, 1998, which discusses a system that uses a wide-angle camera to detect people in a scene. Peixoto et al. uses a ground plane assumption to infer 3D position of a person under observation. This 3D position is then used to initialize a binocular-active camera to track the person. Optic flow from the binocular camera images is then used in smooth pursuit of the target.

Another study, by Collins, Lipton, Fujiyoshi, and Kanade, “Algorithms for cooperative multisensor surveillance,” Proc. IEEE, Vol. 89, No. 10, October 2001, presents a wide area surveillance system using multiple cooperative sensors. The goal of Collins et al. system is to provide seamless coverage of extended areas of space under surveillance using a network of sensors. That system uses background subtraction to detect objects or targets under observation, and normalized cross correlation to track such targets between frames and classify them into people and different types of objects such as vehicles.

Collins et al. also performs human motion analysis using a star-skeletonization approach. This approach covers both triangulation and the ground plane assumption to determine the 3D position of objects. The camera-derived positions are combined with a digital elevation map. The system has 3D visualization capability for tracked objects and a sophisticated processing.

Another related system is described in Stillman, Tanawongsuwan and Essa, “A System for Tracking and Recognizing Multiple People with Multiple Cameras,” Georgia TR# GIT-GVU-98-25, August 1998. Stillman et al. presents a face recognition system for at most two people in a particular scene. The system uses two static and two pan-tilt-zoom (PTZ) cameras. The static cameras are used to detect people that are being observed and to estimate their 3D position within the field of view of the cameras. This 3D position is used to initialize the PTZ camera. The PTZ camera images are used to track the target smoothly and recognize faces. The tracking functionality of Stillman et al. is performed with the use of the PTZ camera and face recognition is performed by “Facelt” a commercially available package from Identix Corporation found on the Internet at http://www.identix.com/.

### SUMMARY OF THE INVENTION

The present invention fixes drawbacks of prior art systems including
Scaling, existing systems are unable to cope with any real world environment, e.g., an airport, or sports arena, typically filled with large numbers of people, for lack of a mechanism for managing the camera resources to ensure appropriate imaging of all people within the sample space.
Frontal Requirement, prior art systems require that all people under surveillance face the camera as those use face detection. This condition is not met in most real world environments.
Continuity of Identity, prior art systems use the wide baseline stereo mechanism for initialization only, thereby preventing maintenance of continuous tracking of all people within the sample space.
Imaging Selected Parts, because the prior art systems are inherently tied to the Frontal Requirement discussed above, acquisition of high-resolution pictures of other parts, e.g., hands or legs, cannot be applied when necessary.

The level of security at a facility is directly related to how well the facility can keep track of whereabouts of employees and visitors in that facility, i.e., knowing “who is where?” The “who” part of this question is typically addressed through the use of face images collected for recognition either by a person or a computer face recognition system. The “where” part of this question can be addressed through 3D position tracking. The “who is where” problem is inherently multi-scale, and wide-angle views are needed for location estimation and high-resolution face images for identification.

A number of other people tracking challenges, like activity understanding, are also multi-scale in nature. Any effective system used to answer “who is where” must acquire face images without constraining the users and must closely associate the face images with the 3D path of the person. The present solution to this problem uses computer controlled pan-tilt-zoom cameras driven by a 3D wide-baseline stereo tracking system. The pan-tilt-zoom cameras automatically acquire zoomed-in views of a person's head, while the person is in motion within the monitored space.

It is therefore an object of the present invention to provide an improved system and method for obtaining information about objects in a three dimensional space.

It is another object of the present invention to provide an improved system and method for tracking and obtaining information about objects in a three-dimensional space.

It is yet another object of the present invention to provide an improved system and method for obtaining information about objects in a three-dimensional space using only positional information.

It is a further object of the present invention to provide an improved system and method for obtaining information about a large number of selected objects in a three dimensional space by using only positional information about selected objects.

It is yet another object of the present invention to provide an improved system and method for obtaining information about moving objects in a three dimensional space.

It is still yet another object of the present invention to provide an improved system and method for obtaining information about selected objects in a three dimensional space.

It is still yet another object of the present invention to provide an improved system and method for obtaining information about selected parts of selected objects in a three dimensional space.

The present invention provides a system and method for selectively monitoring movements of objects, such as people, animals, and vehicles, having various color, size, etc., attributes in a three dimensional space, for example an airport lobby, amusement park, residential street, shipping and receiving docks, parking lot, a retail store, a mall, an office building, an apartment building, a warehouse, a conference room, a jail, etc. The invention is achieved by using static sensors to detect position information of objects, e.g., humans, animals, insects, vehicles, or any moving objects, by collecting the selected object's attribute information, e.g., a color, size, shape, an aspect ratio, and speed, e.g., multi-camera tracking systems; a sound, infrared, GPS, lorad, sonar positioning system, a radar; static cameras, microphones, motion detectors, etc., positioned within the three dimensional space. The inventive system receives visual data and positional coordinates regarding each detected object from the static sensors and assigns positional coordinate information to each of the detected objects.

Detected objects of interest are selected for monitoring. Objects are selected based on their attributes in accordance to a predefined object selection policy. Selected objects are uniquely identified and assigned variable sensors for monitoring. Variable sensors are movable in many directions and include cameras, directional microphones, infrared or other type sensors, face and iris recognition systems. Variable sensors are controlled and directed within the respective range to the identified object by using position and time information collected from the selected control attributes.

Information for each identified object is continuously gathered according to a predefined information gathering policy, from the variable sensors, e.g., pan-tilt-zoom cameras, microphones, etc., to detect a direction of each selected object in the three dimensional space. As the selected object moves, the variable sensors assigned to that object are controlled to continuously point to the object and gather information. The information gathering policy provides specifics regarding a range of the selected control attributes to be selected on the identified object.

### BRIEF DESCRIPTION OF THE DRAWINGS

The foregoing and other objects, aspects, and advantages of the present invention will be better understood from the following detailed description of preferred embodiments of the invention with reference to the accompanying drawings that include the following:

FIG. 1 is a diagrammatic view of a selective surveillance system of the present invention;

FIG. 2 is a flow diagram of the selective surveillance system of FIG. 1;

FIG. 3 is a flow chart of the active camera management system of FIG. 2;

FIG. 4 is a flow chart of a two-dimensional tracking system of the present invention;

FIG. 4a shows the evolution of an appearance model for a van from the photographic equipment test system data of the system of FIG. 4;

FIG. 5 is a flow chart of a three-dimensional tracking system of the present invention;

FIG. 6 is a floor plan overlaid with an output of the selective surveillance system of the present invention showing a path of a registered; and

FIG. 7 is a floor plan overlaid with an output of the selective surveillance system of the present invention showing a high resolution image of a recognized object correlated to object's location on the floor.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

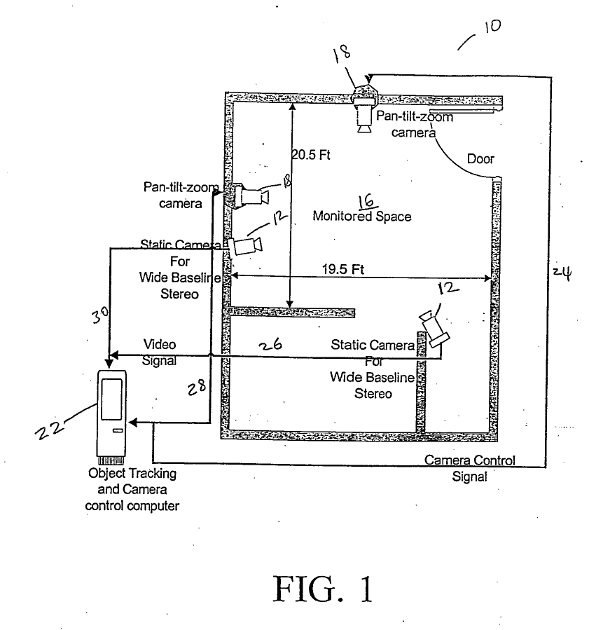

FIG. 1 illustrates a block diagram of a setup of the selective surveillance system 10 of the present invention. The system 10 includes static cameras 12 having overlapping fields of view over a monitored space 16 and are used for wide baseline stereo triangulation. The system 10 further includes pan-tilt-zoom cameras 18 used to zoom in on targets moving across the monitored space 16. All cameras, both static 12 and pan-tilt 18 cameras are calibrated to a common coordinates system.

The monitored space 16, as used in the present example, is an area of about 20 ft×19 ft. Other areas may include an airport lobby, amusement park, residential street, shipping and receiving docks, parking lot, a retail store, a mall, an office building, an apartment building, a warehouse, a conference room, a jail, etc. Tracking and camera control components of the selective surveillance system 10 are programs of instructions executing in real time on a computing device such as tracking server 22, for example, a dual 2 GHz Pentium computer. It is understood by those skilled in the art that a variety of existing computing devices can be used to accommodate programming requirements of the invention.

The invention further includes a video recorder that may be implemented on the same or a separate computing device. The tracking server 22 and recording server (not shown) may communicate via a socket interface over a local area network or a wide area network such as the Internet. Cameras 12 and 18 communicate with the tracking server 22 via connections 24-30; they receive camera control signals and return video content signals to the tracking server 22 which in turn may forward such signals to the recording server.

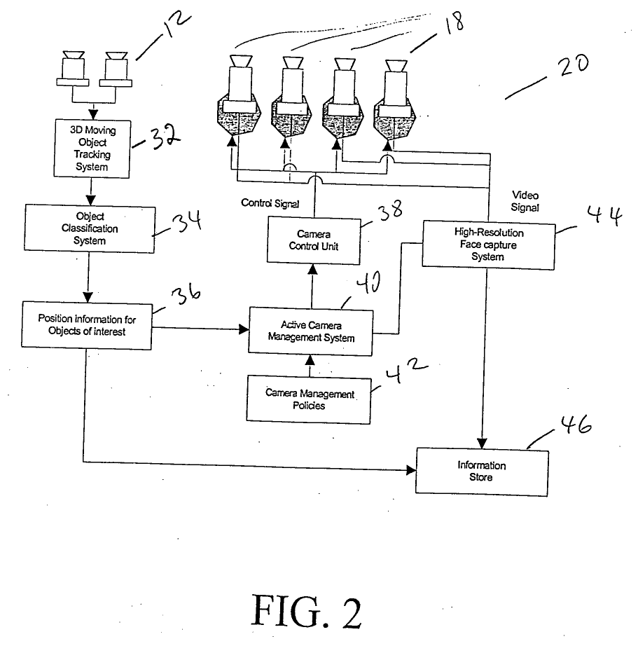

FIG. 2 shows a block diagram 20 of the selective surveillance system 10 (FIG. 1). There are two sets of cameras shown. The first is a set of two cameras 12 which have an overlapping field of view. The area of overlap between the two cameras is called the monitored space 16 (FIG. 1). Cameras 12 are fixed in their position and will be called static cameras throughout the specification. The second set of cameras consists of one or more pan-tilt-zoom cameras 18. These cameras 18 may be controlled, such that they can be rotated, i.e., pan and tilt, and their focal length may be changed to provide optical zoom. The control of cameras 18 may be achieved through the use of a computing device.

The static cameras 12 are used by the selective surveillance system 10, to detect and track all objects moving in the overlapping fields of views of the two static cameras 12. This is accomplished by a 3D tracking system 32, which provides position and track history information for each object detected in the monitored space 16. Each of the detected objects is then classified into a set of classes, such as for example, people, vehicles, shopping carts, etc. by the object classification system 34. The position and tracking information is collected by a processor 36 for storing on a mass storage device 46 attached to the computing device 22 and to be used by the active camera management system (ACMS) 40.

Additionally, the ACMS 40 receives pre-specified camera management policies and the current state of the system from a processor 42 and uses it in conjunction with the tracking information to select a subset of current objects and a subset of the pan-tilt-zoom cameras 18 for continued tracking of the object. The cameras 18 are selected to be the most appropriate to acquire higher-resolution images of the selected objects using the pan-tilt and zoom parameters. The camera control unit 38 then commands selected cameras to collect necessary high-resolution information and provide it to a high-resolution face capture system 44 for processing. The output of the pan-tilt-zoom cameras 18 is then processed by the high resolution face capture system 44, which associates the high-resolution information to tracking information for both storage and other purposes, including for input into a face recognition system (not shown). Information storage device 46 may selectively store information received from process 36 and from high-resolution face capture system on local storage devices, e.g., magnetic disk, compact disk, magnetic tape, etc., or forward it via a network such as the Internet to a remote location for further processing and storage.

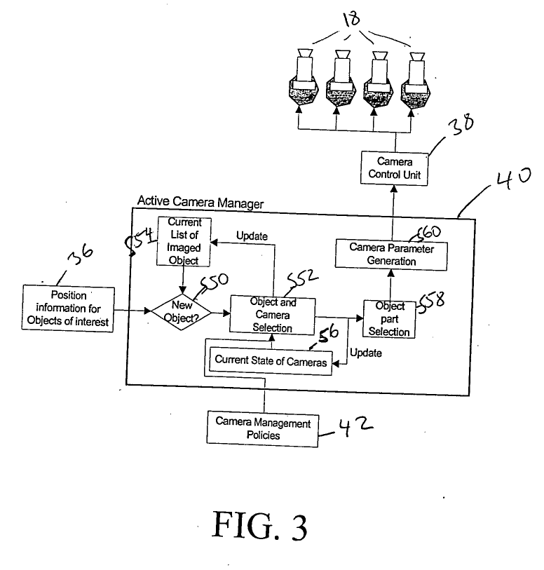

FIG. 3 shows a flow chart of components of the ACMS 40 for performing two functions. First is the function of assigning a fixed number of pan-tilt-zoom cameras 18 to objects being tracked that are active within the monitored space. That function is performed by a camera assignment module (not shown). The second function, controlling the pan-tilt-zoom parameters of the selected camera 18 on an ongoing basis, is performed by a camera parameter control (not shown).

The camera assignment module functionality may be performed by a resource allocation algorithm. The resource allocation task may be simplified when the number of active cameras 18 is greater than the number of currently active tracked objects. However, in all cases a number of different policies can be followed for assigning cameras 18 to the subjects in the monitored space 16 (FIG. 1). The choice of policy followed is driven by the application goals, for example:
Location-Specific Assignment: cameras 18 are assigned to objects moving near specific locations within the monitored space 16, for example near entrances.
Orientation-Specific Assignment: cameras 18 in front of an object are assigned to that object to obtain the clearest view of each object's specific area, such as a person's face.
Round Robin Sampling: cameras 18 are periodically assigned to different objects within the monitored space 16 to uniformly cover all objects with close-up views.
Activity Based Assignment: cameras 18 may be assigned to objects performing a specific activity, for example, in an airport cameras 18 may be automatically assigned to track anyone who is running.

As described above with reference to FIG. 2, ACMS 40 receives position and tracking information collected by the position information process 36 and specified camera management policies and the current state of the system from the policies management process 42. Position information is evaluated in step S50 to determine if the object of interest is a new object in the monitored space 16 (FIG. 1) or an existing object requiring a new camera assignment. To prevent duplication, step S50 evaluates a list of imaged objects provided in step S54 stored in memory or mass storage 46 of the computing device 22.

At step S52 the new object is assigned a camera 18 to operate according to camera management policies, described above, received from policies management process 42. To prevent duplication and mismanagement, step S52 evaluates additional information on the current state of cameras 18 from a list determined in step S56. After one or more cameras 18 have been assigned to the new object, or reassigned to an existing object, the lists of current imaged objects provided in step S54 and current state of cameras determined in step S56 are updated at step S52 and control is passed to step S58.

At step S58 a selection is made of a particular part or body part of the object on which the assigned camera or cameras 18 should focus. The physical or actual camera parameters in three-dimensions corresponding to where the camera will focus are generated in step S60.

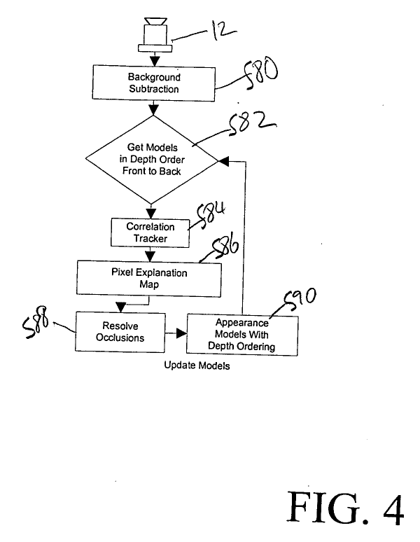

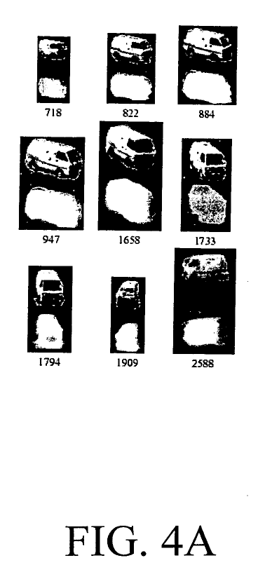

FIG. 4 shows key steps performed by the 3D multi-blob tracking system. The 2D blob tracking relies on appearance models, which can be described as image templates. A description of appearance-based tracking may be found in a paper “Appearance Models for Occlusion Handling” by Andrew Senior, Arun Hampapur, Ying-Li Tian, Lisa Brown, Sharath Pankanti and Ruud Bolle published in Proceedings 2nd IEEE Int. Workshop on PETS, Kauai, Hi., USA, in Dec. 9, 2001, the contents of which are incorporated herein by reference. Specifically, that document teaches that to resolve complex structures in the track lattice produced by the bounding box tracking, appearance based modeling can be used. An appearance model, showing how an object appears in an image, is built for each track. The appearance model is an RGB color model with a probability mask similar to that used by Haritaoglu, D. Harwood, and L. S. Davis. W4: Real-time surveillance of people and their activities. IEEE Trans. Pattern Analysis and Machine Intelligence, 22(8): 809-830, August 2000. As the track is constructed, the foreground pixels associated with it are added into the appearance model. The new information is blended in with an update fraction (typically 0.05) so that new information is added slowly and old information is gradually forgotten. This allows the model to accommodate to gradual changes such as scale and orientation changes, but retain some information about the appearance of pixels that appear intermittently, as in the legs or arms of a moving person. The probability mask part is also updated to reflect the observation probability of a given pixel. These appearance models are used to solve a number of problems, including improved localization during tracking, track correspondence and occlusion resolution.

FIG. 4a shows the evolution of an appearance model for a van from the photographic equipment test system (PETS) data at several different frames. In each frame, the upper image shows the appearance for pixels where observation probability is greater than 0.5. The lower shows the probability mask as gray levels, with white being 1. The frame numbers at which these images represent the models are given, showing the progressive accommodation of the model to slow changes in scale and orientation.

Returning now to FIG. 4, new appearance models are created when an object enters a scene and cameras 12 capture its image. In every new frame, each of the existing tracks is used to explain the foreground pixels using background subtraction in step S80. The fitting mechanism used is correlation, implemented as minimization of the sum of absolute pixel differences over a predefined search area. During occlusions, foreground pixels may be overlapped by several appearance models. Color similarity is used, to determine which appearance model lies in front and to infer a relative depth ordering for the tracks.

Once this relative depth ordering is established in step S82, the tracks are correlated in order of depth in step S84. In step S86, the correlation process is gated by the explanation map, which holds at each pixel the identities of the tracks explaining the pixels. Thus foreground pixels that have already been explained by a track do not participate in the correlation process with more distant models. The explanation map is then used to resolve occlusions in step S88 and update the appearance models of each of the existing tracks in step S90. Regions of foreground pixels that are not explained by existing tracks are candidates for new tracks to be derived in step S82.

A detailed discussion of the 2D multi-blob tracking algorithm can be found in “Face Cataloger: Multi-Scale Imaging for Relating Identity to Location” by Arun Hampapur, Sharat Pankanti, Andrew Senior, Ying-Li Tian, Lisa Brown, Ruud Bolle, to appear in IEEE Conf. on Advanced Video and Signal based Surveillance Systems, 20-22 July 2003, Miami Fla. (Face Cataloger Reference), which is incorporated herein by reference. The 2D multi-blob tracker is capable of tracking multiple objects moving within the field of view of the camera, while maintaining an accurate model of the shape and color of the object.

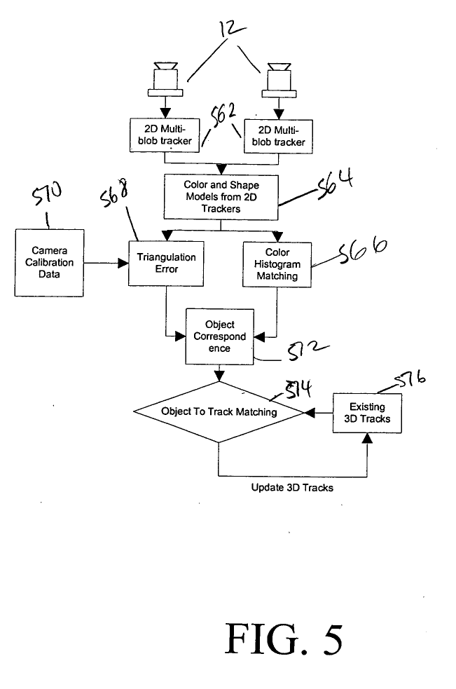

FIG. 5 shows a flow chart of the 3D tracker that uses wide baseline stereo to derive the 3D positions of objects. At every frame, the color distance between all possible pairings of tracks from the two views is measured in step S64. The Bhattacharya distance, described in Comanicui D, Ramesh V and Meer P, Real Time Tracking of Non-Rigid Objects using Mean Shift, IEEE Conf on Computer Vision and Pattern Recognition, Vol. II, 2000, pp 142-149, is used between the normalized color histograms of the tracks received. For each pair, the triangulation error is measured in step S68, which is defined as the shortest 3D distance between the rays passing through the centroids of the appearance models in the two views. The triangulation error is generated using the camera calibration data received from step S70. To establish correspondence the color distance between the tracks from the view with the smaller number of tracks to the view with the larger number is minimized in step S72. This process can potentially lead to multiple tracks from one view being assigned to the same track in the other. The triangulation error in step S68 is used to eliminate such multiple assignments. The triangulation error for the final correspondence is thresholded to eliminate spurious matches that can occur when objects are just visible in one of the two views.

Once a correspondence is available at a given frame, a match between the existing set of 3D tracks and 3D objects present in the current frame is established in step S74. The component 2D track identifiers of a 3D track are used and are matched against the component 2D track identifiers of the current set of objects to establish the correspondence. The system also allows for partial matches, thus ensuring a continuous 3D track even when one of the 2D tracks fails. Thus the 3D tracker in step S74 is capable of generating 3D position tracks of the centroid of each moving object in the scene. It also has access to the 2D shape and color models from the two views received from cameras 12 that make up the track.

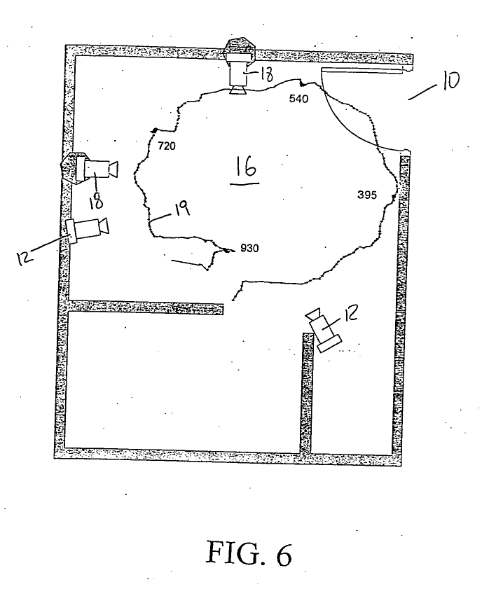

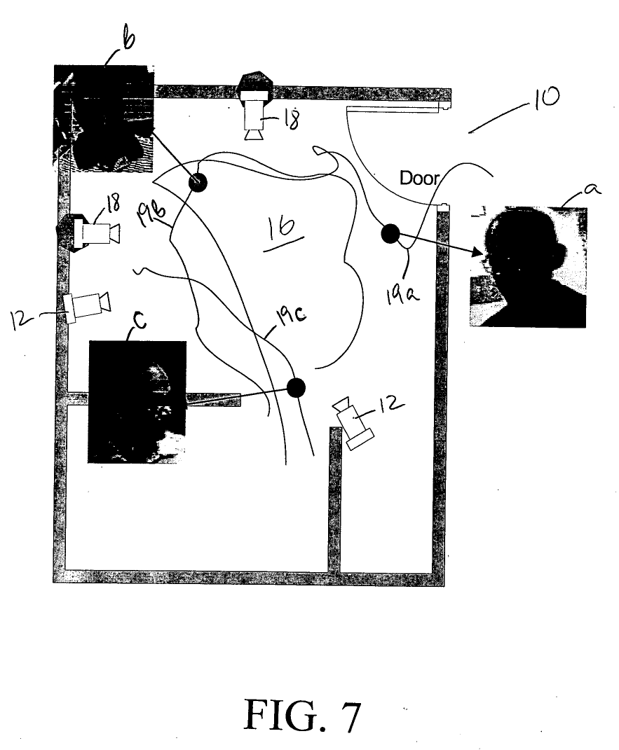

FIGS. 6 and 7 illustrate a resulting output sample run 19 of the selective surveillance system 10 computed by the computing system 22 (FIG. 1). The system 10 includes static cameras 12 having overlapping fields of view over a monitored space 16 and are used for wide baseline stereo triangulation. The system 10 further includes pan-tilt-zoom cameras 18 used to zoom in on targets moving across the monitored space 16. All cameras, both static 12 and pan-tilt 18 cameras are calibrated to a common coordinates system. The monitored space 16, as used in the present example, is an area of about 20 ft×19 ft. The resulting output sample run 19 shows a path of a person tracked walking through the monitored space 16.

FIG. 7 illustrates multi-track output sample runs 19a-19c of three persons a-c. The output or display provided by the computing system 22 (FIG. 1) can easily identify each path 19a-19c with a close-up photo of the object a-c. Furthermore, corresponding static and close-up camera images taken along the paths 19a-19c can be displayed on request or according to a pre defined rules along the path corresponding to locations where this video was acquired using the sub-linear zoom policy discussed above. Clearly the close-up images have much more information relating to identity. These images can be stored in conjunction with the tracks or used as input to an automatic face recognition system.

While the invention has been shown and described with reference to certain preferred embodiments thereof, it will be understood by those skilled in the art that various changes in form and details may be made therein without departing from the spirit and scope of the invention as defined by the appended claims.

1. A selective surveillance system for acquiring high resolution information about one or more objects in a three dimensional space being monitored, said objects having one or more object attributes, said system including one or more static sensors, a plurality of variable sensors, and a computing device for controlling said static and variable sensors, said static and variable sensors having one or more control attributes, said system comprising:
a position detection means for selecting and uniquely identifying each object of said one or more objects under surveillance;
a position tracking means for maintaining continuity of identity of all objects within the three dimensional space;
a means for gathering additional information about one or more selected objects from said variable sensors and controlling said one or more variable sensors in following said one or more objects under surveillance by using said position information.

2. The system of claim 1, wherein the one or more objects are selected from the group consisting of a human, an animal, an insect, a vehicle, and a moving object.

3. The system of claim 1, where the one or more object attributes are selected from the group consisting of a color, a size, a shape, an aspect ratio, and speed.

4. The system of claim 1, wherein said static sensors are selected from the group consisting of multi-camera tracking systems, a sound positioning system, an infrared positioning system, a GPS, a lorad positioning system, a sonar positioning system, and a radar.

5. The system of claim 1, wherein said variable sensors are movable in a plurality of directions and are selected from the group consisting of a camera, a directional microphone, an infrared sensor, a face recognition system, and an iris recognition system.

6. The system of claim 1, wherein said variable sensors are one or more cameras and said control attributes include a camera zoom measurement.

7. The system of claim 1, wherein said control attributes are selected from the group consisting of a pan, a zoom, and a tilt.

8. The system of claim 1, wherein the one or more object attributes are selected manually.

9. The system of claim 1, wherein said position detection means further includes an object selection policy, wherein said object is selected according to said object attributes compatible with said object selection policy.

10. The system of claim 1, wherein said position detection means receives from said static sensors visual data and positional coordinates regarding said each object and assigns positional information to said each object.

11. The system of claim 1, wherein said means for gathering further include an information gathering policy, wherein gathering information is achieved by selecting one or more control attributes and specifying a range of the selected control attributes.

12. The system of claim 11, wherein said means for gathering directs said plurality of variable sensors to said selected object by using position and time information, wherein the position and time information is collected from the selected control attributes to control said plurality of variable sensors within the respective range.

13. A surveillance system, comprising:
a position detection means having one or more sets of cameras that visually monitor one or more objects that are moving in a three dimensional space, the position detection system uniquely identifying the respective objects with object position information at a time, the objects having one or more attributes;
an object selection policy means for selecting one or more of the objects that have attributes compatible with an object selection policy;
one or more pan-tilt-zoom cameras capable of sensing visual information from the objects and able to point the pan-tilt-zoom camera in a plurality of directions; and
a positioning means for controlling the positioner to point the pan-tilt-zoom camera to the object by using the object position information and time.

14. A method for selectively monitoring movement of one or more objects in a three dimensional space, said objects having one or more object attributes, said method comprising the steps of:
detecting a position of the one or more objects in said three-dimensional space by collecting information from one or more static sensors;
selecting each said detected object for monitoring;
uniquely identifying said selected object;
assigning one or more variable sensors to monitor said uniquely identified object;
gathering information from said variable sensors for each said identified object;
detecting a direction of each said identified object in said three dimensional space; and
controlling said one or more variable sensors to continuously track to said identified object.

15. The method of claim 14, wherein a computing device is used for controlling said static and variable sensors, said static and variable sensors having one or more control attributes.

16. The method of claim 15, further comprising a step of selecting one or more parts of said identified object and gathering information about each selected part.

17. The method of claim 16, further comprising a step of classifying one or more of the said identified object into one or more classes and gathering information about each class, wherein the information gathering policy is different for each class.

18. A computer program device readable by a machine, tangibly embodying a program of instructions executable by the machine to perform method steps for selectively monitoring movement of one or more objects in a three dimensional space, said objects having one or more object attributes, said method comprising the steps of:
detecting a position of the one or more objects in said three-dimensional space by collecting information from one or more static sensors;
selecting each said detected object for monitoring;
uniquely identifying said selected object;
assigning one or more variable sensors to monitor said uniquely identified object;
gathering information from said variable sensors for each said identified object;
detecting a direction of each said identified object in said three dimensional space; and
controlling said one or more variable sensors to continuously point to said identified object.

19. The computer program device of claim 18, wherein a computing device is used for controlling said static and variable sensors, said static and variable sensors having one or more control attributes.

20. The computer program device of claim 19, further comprising a step of selecting one or more parts of said identified object and gathering information about each selected part.

21. The computer program device of claim 19, further comprising a step of classifying one or more of the said identified object into one or more classes and gathering information about each class, wherein the information gathering policy is different for each class.
